(19) United States
(12) Patent Application Publication
(10) Pub. No.: US 2014/0057685 A1
(43) Pub. Date: Feb. 27, 2014

(54) Cell Phone Case Audio Amplifying Device

(71) Applicant: Eason Shih, Changhua County (TW)

(72) Inventor: Eason Shih, Changhua County (TW)

(21) Appl. No.: 13/804,359

(22) Filed: Mar. 14, 2013

(30) Foreign Application Priority Data
Aug. 27, 2012 (TW) 101216380

(51) Int. Cl. H04M 1/02

(52) U.S. Cl. CPC H04M 1/0202
USPC 455/575.1

(57) ABSTRACT

A cell phone case audio amplifying device includes a cell phone case. The cell phone case has a sound wave guiding duct or a sound wave guiding trench corresponding in position to an audio outlet of a speaker of a cell phone. The sound wave guiding duct opens at two ends thereof and widens gradually while extending lengthwise to thereby amplify sound at least threefold. A sound wave outlet is disposed on a lateral side of the cell phone case. The sound wave outlet is in communication with a largest opening side of the sound wave guiding duct. The sound wave outlet enables the amplified sound to propagate to the outside efficiently, such that the cell phone case is capable of audio amplification.

### BACKGROUND OF THE INVENTION

1. Technical Field

The present invention relates to cell phone cases, and more particularly, to a cell phone case audio amplifying device for guiding and amplifying sound efficiently such that the output sound is amplified at least threefold.

2. Description of Related Art

Cell phones are indispensable to our daily life, and are so popular with consumers that it is not uncommon for a consumer to own several cell phones. Due to their high portability, conventional cell phones are typically lightweight, thin, and compact. Conventional cell phones have finite internal space and thus cannot be equipped with a high-power speaker, thereby resulting in a low volume level. As a result, in an outdoor setting or a noisy environment, the ringing sound of conventional cell phones is so weak that important calls are often missed and audio playing function is unavailable. Nonetheless, cell phone manufacturers have not yet come up with a solution for solving the aforesaid problem.

### SUMMARY OF THE INVENTION

It is an objective of the present invention to provide a cell phone case audio amplifying device with a cell phone case having a sound wave guiding trench or a sound wave guiding duct that opens at two ends thereof to thereby increase the volume level of a cell phone at least threefold, such that the cell phone case not only protects the cell phone but also increases the volume level of the cell phone.

In order to achieve the above and other objectives, the present invention provides a cell phone case audio amplifying device comprising a cell phone case. The cell phone case has a sound wave guiding trench or a sound wave guiding duct with two ends each having an outlet. The sound wave guiding trench or the sound wave guiding duct corresponds in position to an audio outlet of a speaker of the cell phone and widens gradually while extending lengthwise, so as to amplify sound at least threefold. A sound wave outlet is disposed on a lateral side of the cell phone case. The sound wave outlet is in communication with a largest opening side of the sound wave guiding duct and enables amplified sound to propagate to an outside efficiently, such that the cell phone case is capable of audio amplification.

### BRIEF DESCRIPTION OF THE DRAWINGS

FIG. 1 is a front schematic perspective view of a cell phone case audio amplifying device according to an embodiment of the present invention;

FIG. 2 is a rear schematic perspective view of the cell phone case audio amplifying device according to an embodiment of the present invention;

FIG. 3 is a front exploded view of a cell phone case audio amplifying device and a cell phone according to an embodiment of the present invention;

FIG. 4 is a rear exploded view of the cell phone case audio amplifying device and the cell phone according to an embodiment of the present invention;

FIG. 5 is a schematic perspective view of a cell phone case audio amplifying device according to another embodiment of the present invention;

FIG. 6 is a schematic perspective view of the cell phone case audio amplifying device and a cell phone according to another embodiment of the present invention;

FIG. 7 is a rear exploded view of the cell phone case audio amplifying device and the cell phone according to another embodiment of the present invention;

FIG. 8 is a schematic perspective view of a cell phone case audio amplifying device according to yet another embodiment of the present invention; and

FIG. 9 is a rear exploded view of the cell phone case audio amplifying device and the cell phone according to yet another embodiment of the present invention.

### DETAILED DESCRIPTION OF THE EMBODIMENTS OF THE INVENTION

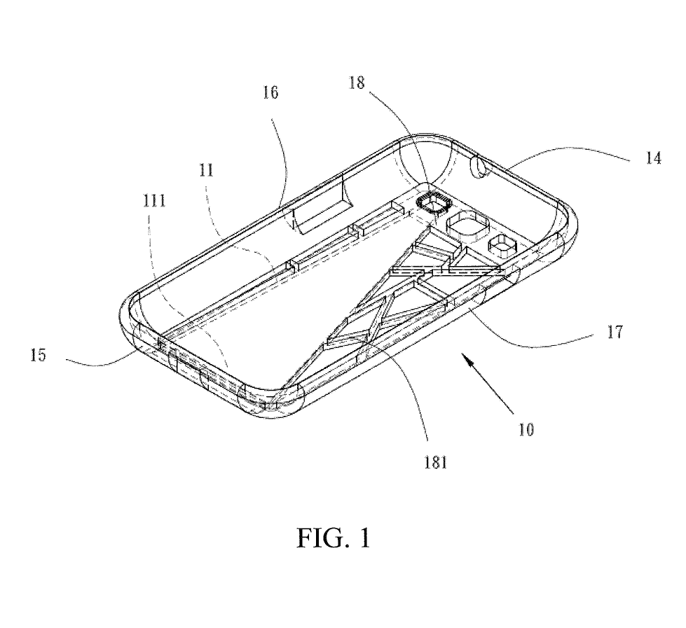

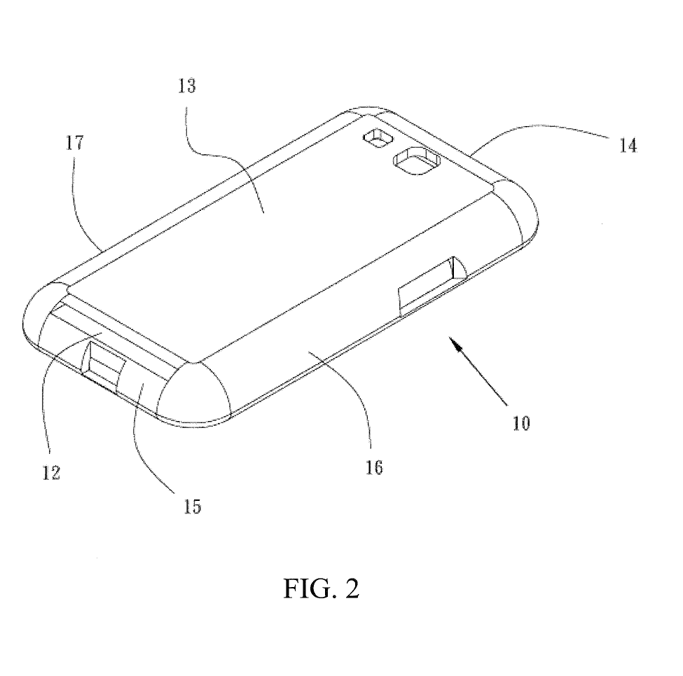

Referring to FIG. 1 and FIG. 2, the present invention provides a cell phone case audio amplifying device, comprising a cell phone case 10. The cell phone case 10 encloses and protects a cell phone 20 and is characterized in that:

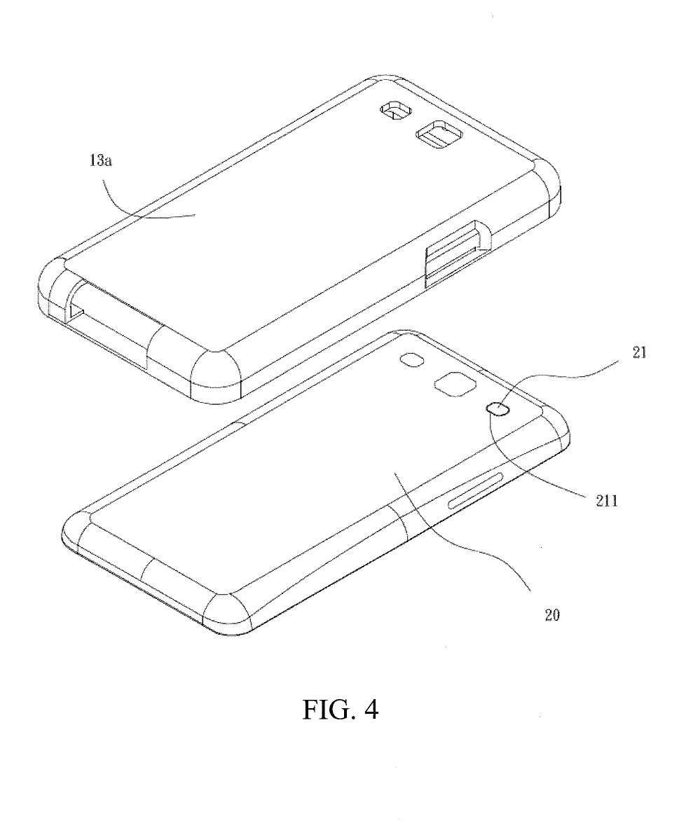

The cell phone case 10 has a sound wave guiding duct 11 with two ends each having an outlet. The sound wave guiding duct 11 corresponds in position to an audio outlet 211 of a speaker 21 (shown in FIG. 4) of the cell phone 20. The sound wave guiding duct 11 widens gradually while extending lengthwise, so as to amplify sound at least threefold. A sound wave outlet 12 is disposed on a lateral side of the cell phone case 10. The sound wave outlet 12 is in communication with a largest opening side 111 of the sound wave guiding duct 11. The sound wave outlet 12 enables the amplified sound to propagate to the outside efficiently, such that the cell phone case 10 is capable of audio amplification.

It is further feasible that the sound wave guiding duct 11 has one said sound wave guiding duct 11 or more.

It is further feasible that the sound wave outlet 12 is disposed on a bottom surface 13, a front side surface 14, a rear side surface 15, a left side surface 16, or a right side surface 17 of the cell phone case 10.

A plurality of protruding ribs 181 is disposed on an inner side surface 18 of the cell phone case 10 and adapted to reinforce the cell phone case 10, reduce the weight thereof, and reduce the amount of plastic required to make the cell phone case 10.

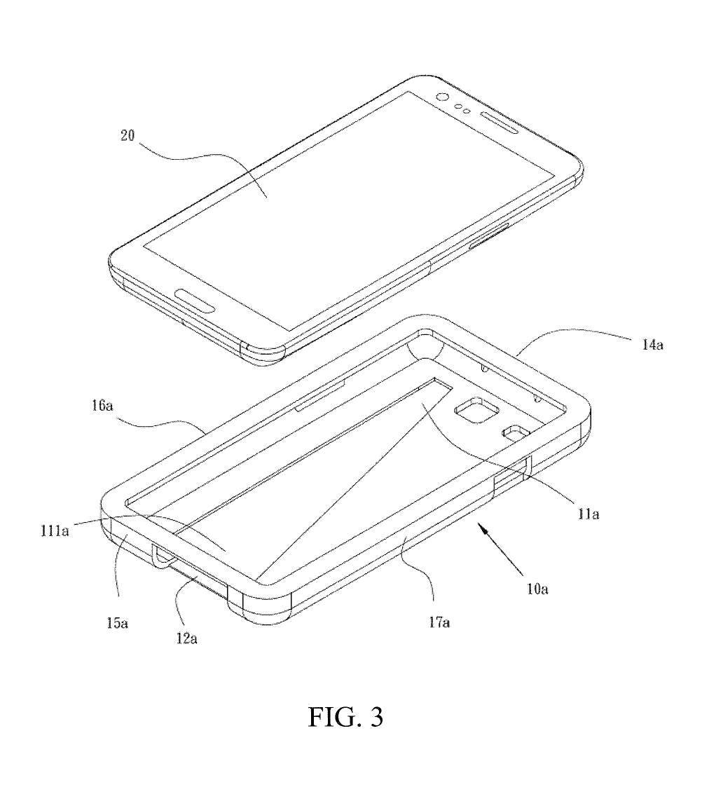

Referring to FIG. 3 and FIG. 4, the present invention provides a cell phone case audio amplifying device, comprising a cell phone case 10a. The cell phone case 10a encloses and protects the cell phone 20 and is characterized in that:

The cell phone case 10a has a sound wave guiding trench 11a corresponding in position to the audio outlet 211 of the speaker 21 of the cell phone 20. The sound wave guiding trench 11a widens gradually while extending lengthwise, so as to amplify sound at least threefold. A sound wave outlet 12a is disposed on a lateral side of the cell phone case 10a. The sound wave outlet 12a is in communication with a largest opening side 111a of the sound wave guiding trench 11a. The sound wave outlet 12a enables the amplified sound to propagate to the outside efficiently, such that the cell phone case 10a is capable of audio amplification.

It is further feasible that the sound wave guiding trench 11a has one said sound wave guiding trench 11a or more.

It is further feasible that the sound wave outlet 12a is disposed on a bottom surface 13a, a front side surface 14a, a rear side surface 15a, a left side surface 16a, or a right side surface 17a of the cell phone case 10a.

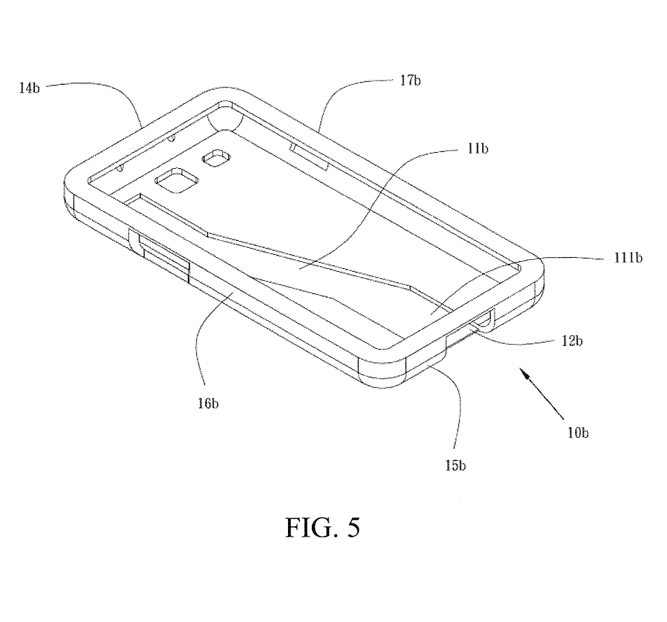

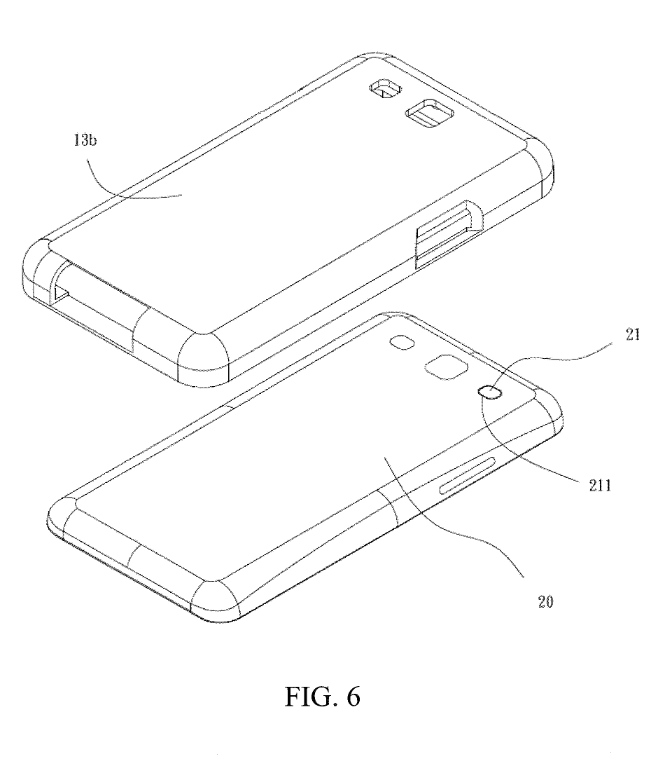

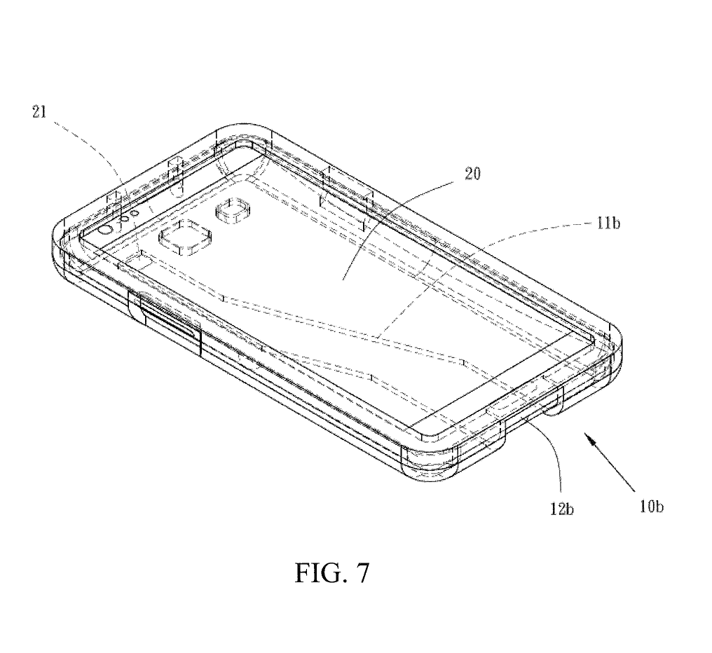

Referring to FIG. 5 through FIG. 7, the present invention provides a cell phone case audio amplifying device, comprising a cell phone case 10b. The cell phone case 10b encloses and protects the cell phone 20 and is characterized in that:

The cell phone case 10b has a sound wave guiding trench 11b corresponding in position to the audio outlet 211 of the speaker 21 of the cell phone 20. The sound wave guiding trench 11b zigzags. The sound wave guiding trench 11b widens gradually while extending lengthwise, so as to amplify sound at least threefold. A sound wave outlet 12b is disposed on a lateral side of the cell phone case 10b. The sound wave outlet 12b is in communication with a largest opening side 111b of the sound wave guiding trench 11b. The sound wave outlet 12b enables the amplified sound to propagate to the outside efficiently, such that the cell phone case 10b is capable of audio amplification.

It is further feasible that the sound wave guiding trench 11b has one said sound wave guiding trench 11b or more.

It is further feasible that the sound wave outlet 12b is disposed on a bottom surface 13b, a front side surface 14b, a rear side surface 15b, a left side surface 16b, or a right side surface 17b of the cell phone case 10b.

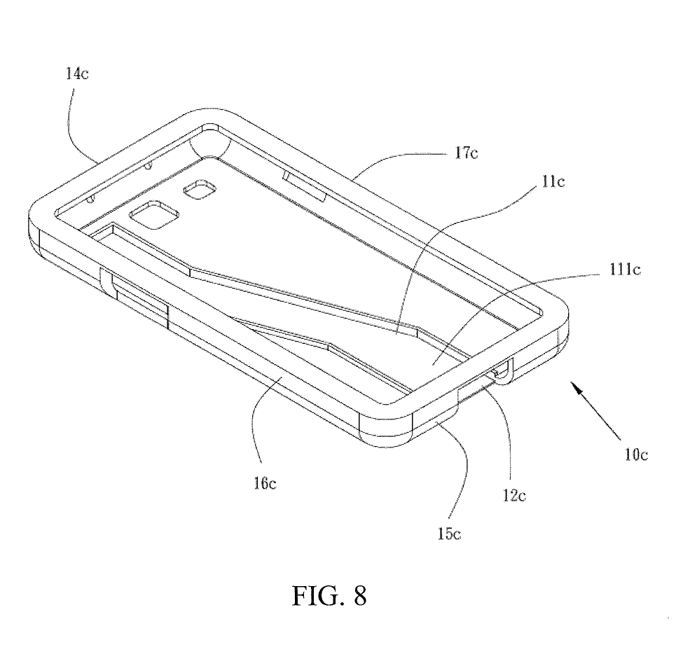

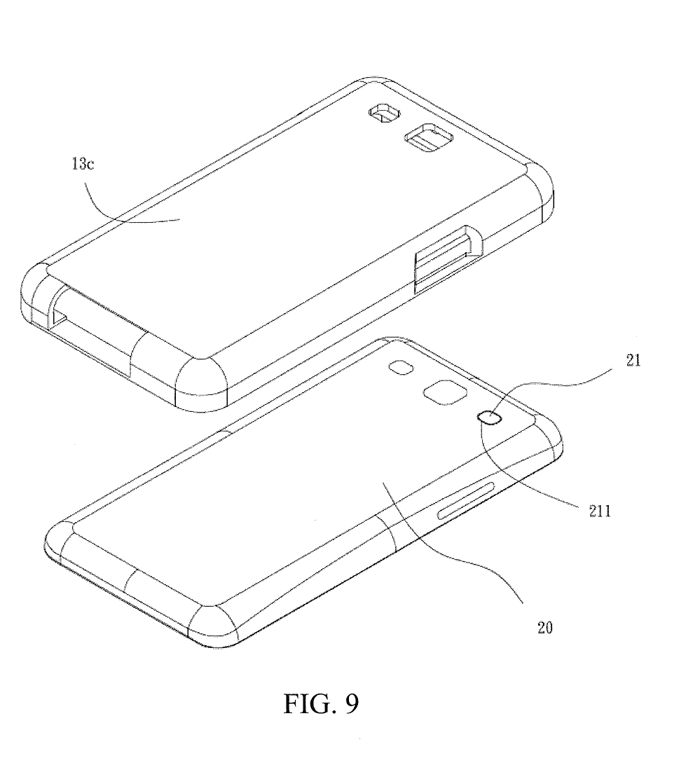

Referring to FIG. 8 and FIG. 9, the present invention provides a cell phone case audio amplifying device, comprising a cell phone case 10c. The cell phone case 10c encloses and protects the cell phone 20 and is characterized in that:

The cell phone case 10c has a sound wave guiding fin-channel 11c corresponding in position to the audio outlet 211 of the speaker 21 of the cell phone 20. The sound wave guiding fin-channel 11c zigzags. The sound wave guiding fin-channel 11c widens gradually while extending lengthwise, so as to amplify sound at least threefold. A sound wave outlet 12c is disposed on a lateral side of the cell phone case 10c. The sound wave outlet 12c is in communication with a largest opening side 111c of the sound wave guiding fin-channel 11c. The sound wave outlet 12c enables the amplified sound to propagate to the outside efficiently, such that the cell phone case 10c is capable of audio amplification.

It is further feasible that the sound wave guiding fin-channel 11c has one said sound wave guiding fin-channel 11c or more.

It is further feasible that the sound wave outlet 12c is disposed on a bottom surface 13c, a front side surface 14c, a rear side surface 15c, a left side surface 16c, or a right side surface 17c of the cell phone case 10c.

What is claimed is:

1. A cell phone case audio amplifying device, comprising:
a cell phone case for enclosing and protecting a cell phone, characterized in that:
the cell phone case has a sound wave guiding duct with two ends each having an outlet, the sound wave guiding duct corresponding in position to an audio outlet of a speaker of the cell phone and widening gradually while extending lengthwise, so as to amplify sound at least threefold, wherein a sound wave outlet is disposed on a lateral side of the cell phone case, wherein the sound wave outlet is in communication with a largest opening side of the sound wave guiding duct and enables amplified sound to propagate to an outside efficiently, such that the cell phone case is capable of audio amplification.

2. The cell phone case audio amplifying device of claim 1, wherein the sound wave guiding duct is provided in one or more.

3. The cell phone case audio amplifying device of claim 1, wherein the sound wave outlet is disposed on a bottom surface, a front side surface, a rear side surface, a left side surface, or a right side surface of the cell phone case.

4. The cell phone case audio amplifying device of claim 1, wherein a plurality of protruding ribs is disposed on an inner side surface of the cell phone case and adapted to reinforce the cell phone case, reduce a weight thereof, and reduce an amount of plastic required to make the cell phone case.

5. A cell phone case audio amplifying device, comprising:
a cell phone case for enclosing and protecting a cell phone, characterized in that:
the cell phone case has a sound wave guiding trench corresponding in position to an audio outlet of a speaker of the cell phone, either zigzagging or not zigzagging, and widening gradually while extending lengthwise, so as to amplify sound at least threefold, wherein a sound wave outlet is disposed on a lateral side of the cell phone case, wherein the sound wave outlet is in communication with a largest opening side of the sound wave guiding trench and enables amplified sound to propagate to an outside efficiently, such that the cell phone case is capable of audio amplification.

6. The cell phone case audio amplifying device of claim 5, wherein the sound wave guiding trench is provided in one or more.

7. The cell phone case audio amplifying device of claim 5, wherein the sound wave outlet is disposed on a bottom surface, a front side surface, a rear side surface, a left side surface, or a right side surface of the cell phone case.

8. A cell phone case audio amplifying device, comprising:
a cell phone case for enclosing and protecting a cell phone, characterized in that:
the cell phone case has a sound wave guiding fin-channel corresponding in position to an audio outlet of a speaker of the cell phone, either zigzagging or not zigzagging, and widening gradually while extending lengthwise, so as to amplify sound at least threefold, wherein a sound wave outlet is disposed on a lateral side of the cell phone case, wherein the sound wave outlet is in communication with a largest opening side of the sound wave guiding fin-channel and enables amplified sound to propagate to an outside efficiently, such that the cell phone case is capable of audio amplification.

9. The cell phone case audio amplifying device of claim 8, wherein the sound wave guiding fin-channel is provided in one or more.

10. The cell phone case audio amplifying device of claim 8, wherein the sound wave outlet is disposed on a bottom surface, a front side surface, a rear side surface, a left side surface, or a right side surface of the cell phone case.
